(19) United States
(12) Patent Application Publication
(10) Pub. No.: US 2009/0150696 A1
(43) Pub. Date: Jun. 11, 2009

(54) Transitioning a processor package to a low power state

(76) Inventors: Justin Song, Olympia, WA (US); Qian Diao, Cupertino, CA (US)

Correspondence Address: TROP, PRUNER & HU, P.C., 1616 S. VOSS RD., SUITE 750, HOUSTON, TX, 77057-2631, US

(21) Appl. No.: 12/001,186

(22) Filed: Dec. 10, 2007

(51) Int. Cl. G06F 1/32

(52) U.S. Cl. 713/323

(57) ABSTRACT

In one embodiment, a processor package is controlled to be in a package low power state for a first portion of an operation interval and in a package active state for a second portion of the operation interval. To enable the low power state, operations scheduled during the first portion are delayed until the second portion. Other embodiments are described and claimed.

### BACKGROUND

Power and thermal management are becoming more challenging than ever before in all segments of computer-based systems. While in the server domain, the cost of electricity drives the need for low power systems, in mobile systems battery life and thermal limitations make these issues relevant. Optimizing a system for maximum performance at minimum power consumption is usually done using the operating system (OS) to control hardware elements. Most modern OS's use the Advanced Configuration and Power Interface (ACPI) standard, e.g., Rev. 3.0b, published Oct. 10, 2006, for optimizing the system in these areas. An ACPI implementation allows a core to be in different power-saving states (also termed low power or idle states) generally referred to as so-called C1 to Cn states. Similar package C-states exist for package-level power savings.

When a core is active, it runs at a so-called C0 state, and when the core is idle, it may be placed in a core low power state, a so-called core non-zero C-state. The core C1 state represents the low power state that has the least power savings but can be switched on and off almost immediately, while an extended deep-low power state (e.g., C3) represents a power state where the static power consumption is negligible, but the time to enter into this state and respond to activity (i.e., back to C0) is quite long.

Package non-zero C-states enable power consumption at lower levels than the package active state (i.e., C0 state). Server workloads rarely drive all cores in same package busy, but even if only one core is active the whole package (including all idle cores) must stay in a high-power C0 state. Since package non-zero C-state entry/exit latency is relatively long (e.g., on the order of 100 to 200 microseconds (μs)), the transient time for all cores being idle usually is not worth using that state, or a performance loss will occur. Thus the OS is unable to take advantage of a package's lower power state benefits, resulting in a package always running at a higher power state than needed.

### BRIEF DESCRIPTION OF THE DRAWINGS

FIG. 1 is a block diagram of a portion of a system in accordance with one embodiment of the present invention.

FIG. 2 is a flow diagram of a method in accordance with one embodiment of the present invention.

FIG. 3 is a flow diagram of a prediction algorithm in accordance with one embodiment of the present invention.

FIG. 4 is a flow diagram of a rescheduling method in accordance with one embodiment of the present invention.

FIG. 5 is a timing diagram of scheduling tasks in accordance with an embodiment of the present invention.

FIG. 6 is a block diagram of a system in accordance with an embodiment of the present invention.

### DETAILED DESCRIPTION

Embodiments may reschedule/delay tasks so that the idle time of all cores of a package can be aligned and extended. In this way, more opportunities exist for using greater low power states, i.e., deeper non-zero package C-states. Embodiments may operate at relatively fine-granularity, e.g., every 500 microseconds (μs), so that latency sensitive workload performance is not degraded. In contrast, a conventional OS scheduler simply leaves all tasks' timing as they are set.

In various embodiments, a predetermined interval, e.g., 500 μs, may be set and during each interval break-event processing may be delayed to make cores in the same package idle together and busy together. Further, the busy times can be stitched to be continuous (i.e., not separated by short idles) so that the idle duration can be extended to accommodate a package deep non-zero C-state's long entry/exit latencies. As described below, a prediction for future core utilization, i.e., for the next operation interval, may be generated. Then, real-time task rescheduling may be performed to enable greater power savings. Note that the C-states described herein are for an example processor such as an advanced Intel® Architecture 32 (IA-32) processor available from Intel Corporation, Santa Clara, Calif., although embodiments can equally be used with other processors. Shown in Table 3 below is an example designation of package C-states available in one embodiment. However, understand that the scope of the present invention is not limited in this regard.

Using a conventional scheduling algorithm, for example a workload at a 15% system load level, the package is in the C0 state for 70% of the time (where the theoretical perfect case for power savings should be 15%). For the remaining 30% of time that the package could enter a non-zero package C-state, a large portion of the package idle time is for less than 500 μs, which typically is not worth package C-state entry/exit transition energy cost to enter a deep package low power state. Assume the follow power consumption levels for an example processor in the package C0, C1, and C3 states:

Power(C0)=130 Watts (W)

Power(C1)=28 W

Power(C3)=18 W

The power consumed in this example using a conventional scheduling policy, is:

Power(C0)*70%+Power(C1)*30%*52%+Power(C3)*30%*48%=97.96 W [EQ. 1]

In contrast, embodiments may provide deeper low power states for longer time periods. For example, in comparison to the above calculation, a processor can be scheduled in accordance with an embodiment of the present invention such that it is the active state for only 20% of the time and a deeper low power state (e.g., package C3) for 80% of the time. In this case, the processor consumes:

Power(C0)*20%+Power(C3)*80%=40.4 W [EQ. 2]

leading to a theoretical upper limit of power saving of 57.56 W (or 58.8%) using an embodiment of the present invention.

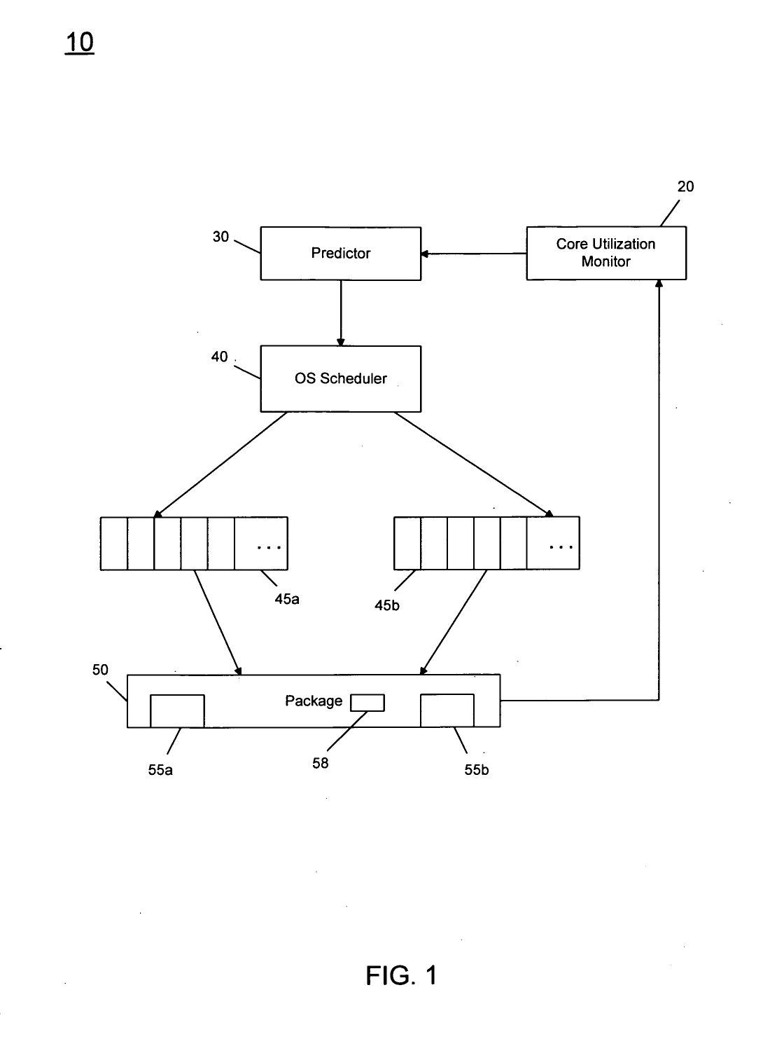

Referring now to FIG. 1, shown is a block diagram of a portion of a system in accordance with one embodiment of the present invention. As shown in FIG. 1, system 10 may be a computer system such as a desktop, server or laptop computer. System 10 may include at least one processor package 50 that includes multiple cores 55ₐ and 55_{b} (generically core 55) and a timer 58, which as will be described further below, acts as a watchdog timer. While shown with only two such cores in the embodiment of FIG. 1, understand the scope of the present invention is not limited in this regard and embodiments may be used in many-core systems. Furthermore, instead of a single package 50, many implementations may be adapted in a system such as a server system having multiple processor packages. As shown in FIG. 1, utilization information from cores 55 may be provided to a core utilization monitor 20. Monitor 20 may be a real-time monitor to capture all cores' central processing unit (CPU) utilization during the monitored interval (e.g., every 500 μs). In one embodiment, the formula to compute utilization, U, is as follows:

U=delta of unhalted core reference clockticks/delta of TimeStamp Counter [EQ. 3]

where the unhalted clock ticks are clock ticks occurring when the core is active and timestamp counter is a timestamp of total processor cycles during the monitored interval. The monitored data from monitor 20 may be provided to a predictor 30.

Predictor 30 may be used to predict future core utilization. In one embodiment, a Kalman filter algorithm prediction of computational complexity O(n) may be performed, where n is number of cores in the same package, such that the prediction can be done in real time. For each prediction interval (e.g., 500 μs), predictor 30 may provide information to an OS scheduler 40 regarding its predictions of the core utilization, which may be on a utilization percentage basis.

In various embodiments, OS scheduler 40 may perform embodiments of the present invention to enable transitioning of the processor package to a lower power state. For example, using embodiments of the present invention, tasks, interrupts and break events to be scheduled on the various cores 55 may be delayed to enable a longer and more continuous idle period in which package 50 can be placed in a deeper low power state. Furthermore, package 50 may remain in this selected low power state for a longer time duration. At the conclusion of this extended idle period, which may be referred to herein as a delay period, the various cores of package 50 may be activated to perform any pending tasks, interrupts or other break events that may have been buffered during the delay period.

Thus based on the predicted core utilizations for the next interval, all incoming break events and tasks can be delayed for the duration of the delay period, referred to herein as a time T* (and which may vary in each operation interval). After that time, all break events and tasks will be serviced.

Since the OS' periodic timer interrupt is also delayed, on each core a watchdog timer 58 may be set with an initial value T*. Note that while in some embodiments, timer 58 may be present in each core 55, in other implementations only a single package timer may be present. When this timer expires, it will create a non-maskable interrupt and wake the corresponding core 55. Cores 55 may then service tasks and break events. In various embodiments buffers 45ₐ and 45_{b} may keep all interrupts received before the watchdog timer expires. Note while shown being coupled between OS scheduler 40 and package 50, such buffers may be associated with various system agents coupled to package 50, such as chipsets, input/output (I/O) devices, peripherals and so forth.

When all cores are idle after rescheduling of tasks, the low-power non-zero package C-state may be entered by processor hardware logic. While shown with this particular implementation in the embodiment of FIG. 1, the scope of the present invention is not limited in this regard. In some embodiments, monitor 20, predictor 30, and scheduler 40 all may be implemented using circuitry of package 50 such as a given core 55, executing software or firmware in accordance with an embodiment of the present invention. Further, OS scheduler 40 may be a given OS adapted to perform rescheduling of tasks within a utilization cycle from their original timing until after the delay period. However, other embodiments may be implemented in other locations such as a performance management unit (PMU) of a given platform.

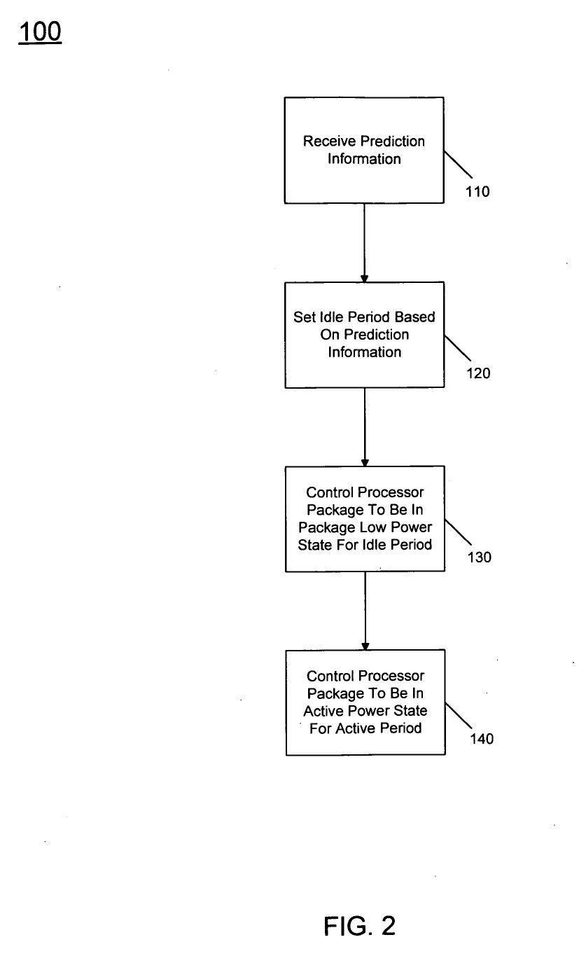

Referring now to FIG. 2, shown is a flow diagram of a method in accordance with one embodiment of the present invention. As shown in FIG. 2, method 100 may be used to determine an idle state for a processor package and control operation of the processor package to be in a low power state for this idle period.

Specifically, as shown in FIG. 2, method 100 may begin by receiving prediction information (block 110). As an example, the prediction information corresponds to utilization rates for each core of a package during a utilization period, which may be a relatively short time period (i.e., 500 μs).

Different predictions may be made in different embodiments. In one embodiment, a Kalman filter model (KFM) may be used to generate the predictions. A KFM models a partially observed stochastic process with linear dynamics and linear observations, both subject to Gaussian noise. It is an efficient recursive filter that estimates the state of a dynamic system from a series of incomplete and noisy measurements. Based on a KFM, the CPU package activity as set forth in a number of predetermined patterns associated with idle-busy states of the package's core (e.g., a percentage of a number of predetermined idle-busy patterns) are considered the observations of a real number stochastic process discretised in the time domain, denoted by y_{1:t}=(y₁ . . . yₜ). The hidden state of the process, x_{1:t}=(x₁ . . . xₜ), is also represented as a vector of real numbers. The linear stochastic different equation in KFM is:

x(t)=Ax(t−1)+w(t−1) p(w)˜N(0,Q) x(0)˜N(x_{1|0}, V_{1|0}) [EQ. 4]

And the measurement equation is:

y(t)=Cx(t)+V(t) p(v)˜N(0, R) [EQ. 5]

The n×n transition matrix A in the difference Equation 4 relates the state at the previous t−1 time step to the state at the current step t, in the absence of either a driving function or process noise. Here n is the number of hidden states. In our task, m=n is the number of possible CPU activity states. x_{1|0}, V_{1|0} are the initial mean and variance of the sate, Q is the system covariance for the transition dynamic noises, and R is the observation covariance for the observation noises. The transition of observation functions is the same for all time and the model is said to be time-invariant or homogeneous.

Using KFM, values can be predicted on the future time, given all the observations up to the present time. However, we are generally unsure about the future, and thus a best guess is computed, as well as a confidence level. Hence a probability distribution over the possible future observations is computed, denoted by P(Yₜ₊ₕ=y|y_{1:t}), where k>0 is the horizon, i.e., how far into the future to predict.

Given the sequence of observed values (y₁-yₜ), to predict the new observation value is to compute p(Yₜ₊ₕ=y|y_{1:t}) for some horizon k>0 into the future. Equation 6 is the computation of a prediction about the future observations by marginalizing out the prediction of the future hidden state.

$$P ( {Y}_{t + h} = y \vert {y}_{1 : t} ) = {\sum }_{x} P ( {Y}_{t + h} = y \vert {X}_{t + h} = x ) P ( {X}_{t + h} = x \vert {y}_{1 : t} ) \qquad [ EQ . 6 ]$$

In the right part of the Equation, we compute P(Xₜ₊ₕ=x|y_{1:t}) by the algorithm of the fixed-lag smoothing, i.e., P(X_{t-L}=x|y_{1:t}), L>0, L is the lag. So before diving into the details of the algorithm, a fixed-lag smoothing in KFM is first introduced.

A fixed-lag Kalman smoother (FLKS) is an approach to perform retrospective data assimilation. It estimates the state of the past, given all the evidence up to the current time, i.e., P(X_{t-L}=x|y_{1:t}), L>0, where L is the lag, e.g., we might want to figure out whether a pipe broke L minutes ago given the current sensor readings. This is traditionally called “fixed-lag smoothing”, although the term “hindsight” might be more appropriate. In the offline case, this is called (fixed-interval) smoothing; this corresponds to computing P(X_{T-L}=x|y_{1:T}), T≧L≧1.

In the prediction algorithm, there are h more forward and backward passes. The computation of the passes is similar to that in the smoothing process. The only difference is that in the prediction step the initial value of the new observation is null, which means y_{1:T+h}=[y_{1:T} yₙᵤₗₗ¹ . . . yₙᵤₗₗ^{h}]. The prediction algorithm estimates the value of the y_{1:T+h}=[y_{1:T} y_{T+1} . . . y_{T+h}] by performing retrospective data assimilation on all the evidence up to the current time plus they y_{1:T+h}=[ŷ_{1:T} yₙᵤₗₗ^{t} . . . yₙᵤₗₗ^{h}]. In practice, we consider using the previous steps as the prior data, for example, if h=1, then y_{T+1}=(y_{T-1}+y_{T})/2 rather than y_{T+1}=null.

Table 1 shows the pseudo code of the prediction algorithm.

TABLE 1

```
function Predicting(y_{1:T},x_{1|0},V_{1|0},A,C,Q,R)
  x_{0|0} = x_{1|0}
  V_{0|0} = V_{1|0}
  y_{T+1} = (y_{T-1}+y_{T})/2;
  for t = 1:T+1
    (x_{t|t},V_{t|t},Lₜ) = Fwd(yₜ,x_{t-1|t-1},V_{t-1|t-1},A,C,Q,R)
  end
  for t = T:−1:1
    (x_{t|T},V_{t|T},V_{t-1,t|T}) = Back(x_{t+1|T},V_{t+1|T},x_{t|t},V_{t|t},A,Q)
  end
```

In Table 1, Fwd and Back are the abstract operators. For each Fwd (forwards pass) operation of the first loop (for t=1:T), we firstly compute the inference mean and variance by x_{t|t-1}=Ax_{t-1|t-1} and V_{t|t-1}=AV_{t-1|t-1}A′+Q; then compute the error in the inference (the innovation), the variance of the error, the Kalman gain matrix, and the conditional log-likelihood of this observation by errₜ=yₜ−Cx_{t|t-1}, Sₜ=CV_{t|t-1}C′+R, Kₜ=V_{t|t-1}C′Sₜ⁻¹, and Lₜ=log(N(errₜ;0,Sₜ) respectively; finally we update the estimates of the mean and variance by x_{t|t}=x_{t|t-1}+Kₜerrₜ and V_{t|t}=V_{t|t-1}−KₜSₜKₜ′.

For each Back (backwards pass) operation of the second loop (for t=T−1:−1:1), at first we compute the inference quantities by x_{t+1|t}=Ax_{t|t} and V_{t+1|t}=AV_{t|t}A′+Q; then compute the smoother gain matrix by Jₜ=V_{t|t}A′V_{t+1|t}⁻¹; finally we compute the estimates of the mean, variance, and cross variance by x_{t|T}=x_{t|t}+Jₜ(x_{t+1|T}−x_{t+1|t}), V_{t|T}=V_{t|t}+Jₜ(V_{t+1|T}−V_{t+1|t})Jₜ′, and V_{t-1,t|T}=Jₜ₋₁V_{t|T} respectively, which are known as the Rauch-Tung-Striebel (RTS) equations.

The computation as set forth in Table 1 can be complicated, e.g., there are matrix inversions in the T+1 step loop, when computing Kalman gain matrix in Fwd operator and the smoother gain matrix in Back operator. And the computational complexity will be O(TN³), where T is the number of history observations; N is the number of activity states, because for a general N*N matrix, Gaussian elimination for solving the matrix inverse leads to O(N³) complexity. However, in various embodiments the algorithm implementation can be simplified.

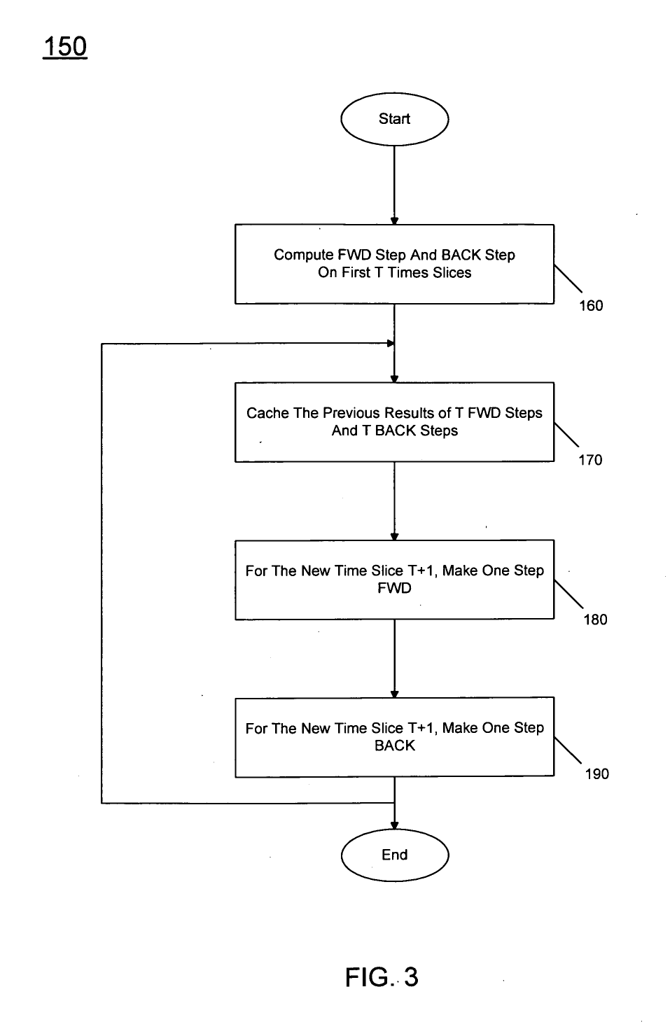

As shown in FIG. 3, which is a flow diagram of a prediction algorithm 150 in accordance with one embodiment of the present invention, the forward and back operations can be computed for a predicted number of intervals (e.g., time slices T=1000) (block 160). Then the previous T step intermediate result of x and V can be cached (block 170), and just one step update of Fwd is made for the new coming time slice T+1 (block 180). Similarly, for the backwards pass, just one step Back operator for the T+1 time slice can be computed (block 190), using the cached previous T step intermediate results. Hence after the simplification, the computational complexity would be O(N³). Furthermore, the N=2^{N′} (N′ is the number of cores inside the same package) processor package activity states can be classified into 3 patterns: all idle, all busy and partial idle, and we use these three patterns to describe the states, so N would become only 3. On the other hand, we simplify the KFM and set A, C, Q, R and initial V as a diagonal matrix with the element values being 0 or 1, to reduce the operation complexity of the algorithm to O(N). While described using this prediction algorithm, embodiments of the present invention are not limited in this regard.

Referring back to FIG. 2, based on this prediction information, an idle period may be set (block 120). Note that blocks 110 and 120 may be implemented in various locations in different embodiments. In one particular embodiment, these blocks may be implemented in an OS, such as within an OS scheduler, although the scope of the present invention is not limited in this regard.

Referring still to FIG. 2, next the processor package may be controlled to be in a package low power state for the idle period (block 130). As will be discussed further below, this low power state may be a deeper low power state than otherwise may be possible. This is so, as the idle period can be a continuous period from the beginning of a next utilization cycle until an active period, which corresponds to the difference between the next utilization cycle length and the idle period length. This control of the processor package may be implemented by receiving OS commands to place the processor package into the selected low power state. However, in other implementations the processor package itself may determine an appropriate low power state based on the duration of the idle period and all its cores' deepest C-state.

At the conclusion of the idle period, the active period is initiated and thus the processor package may be controlled to be in a package active power state (block 140), such as the package C0 state, although the scope of the present invention is not limited in this regard. While shown with this particular implementation in the embodiment of FIG. 2, the scope of the present invention is not limited in this regard.

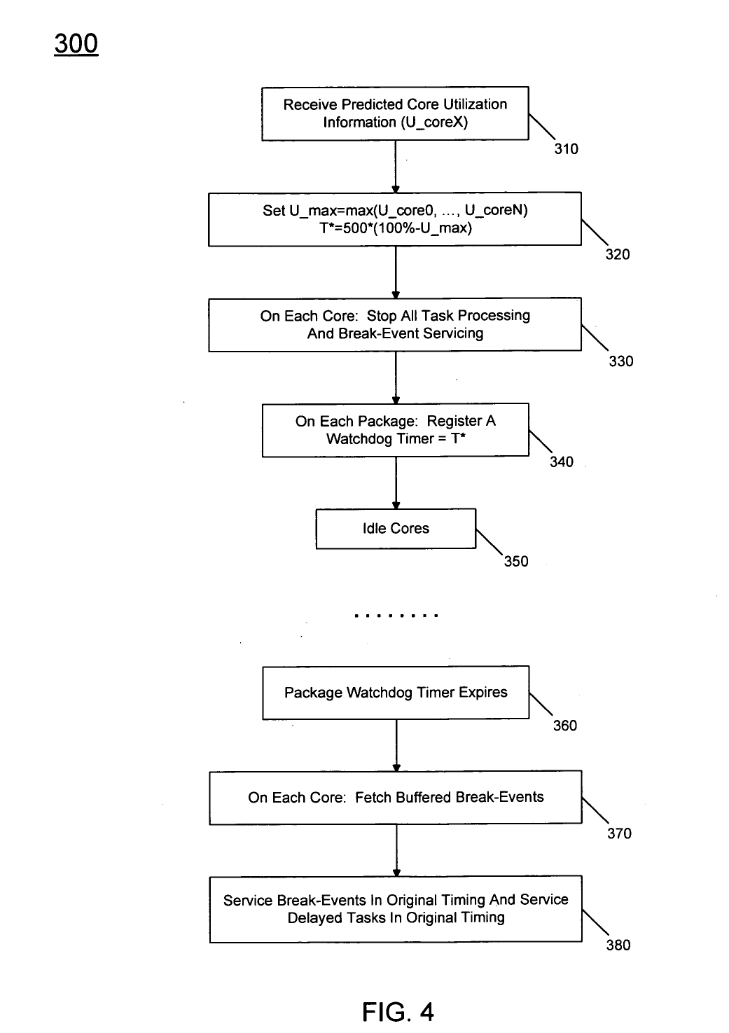

Referring now to FIG. 4, shown is a flow diagram of a rescheduling method in accordance with one embodiment of the present invention. As shown in FIG. 4, method 300 may be implemented by an OS scheduler to receive utilization prediction information and reschedule activities on a package to enable a delay period to be realized such that the package can enter into a low power state, and in many implementations a deep low power state, for the duration of the delay period.

As shown in FIG. 4, method 300 may begin by receiving predicted core utilization information (block 310). More specifically, in various embodiments a predictor, such as predictor 30 of FIG. 1 may provide, for each core of a package, a predicted core utilization to the OS scheduler. In some embodiments, this prediction may be a core utilization value, U_coreX, for each core of the package. In one such embodiment, this utilization value may correspond to a percentage, indicating a predicted percentage of time for a next operation interval in which the core is predicted to be in an active state. However the scope of the present invention is not limited in this regard. For example, in other implementations the percentage information may be a pattern distribution for predicted core states for the next interval. Such pattern distribution may vary widely, depending on a number of low power states supported, as well as a given number of cores, length of the prediction period and so forth. As one example, a pattern distribution can include three different idle-active patterns, although more or fewer such patterns may be provided, e.g., with varying granularities as to a number of cores at a given activity level.

Next, the core with the highest predicted utilization rate may be identified and a maximum utilization rate, U_max, may be set equal to this predicted value (block 320). Furthermore, a delay period, T*, may be set based on this predicted maximum utilization rate. For example, for a next operation interval (NOI), T* may be set equal to NOI×(100%-U_max), where U_max is expressed as a percentage.

Referring still to FIG. 4, at the beginning of the next interval (i.e., at the beginning of a next 500 μs cycle), all task processing and break-event servicing may be stopped on each core (block 330). Furthermore, on each package, a watchdog timer may be registered to a time equal to the delay period, T* (block 340). Then the cores of the package may be idled (block 350). Thus at this time, the package may be placed into a package low power state, such as a package C1 state, although given that the delay period is for an extended and deterministic time, the package can be placed into a deeper low power state, such as the package C3 state, although the scope of the present invention is not limited in this regard. For example, in other implementations based on the core utilization information, if the delay period is set to be longer than a given threshold (e.g., 20% of the 500 μs interval), a deeper package low power state such as a package C6 or C7 state may be entered. Accordingly, for the time of the delay period, the package may remain in this low power state, thus enabling configurable and deeper power savings.

This low power state may thus remain in effect until the package watchdog timer expires (block 360). At this time, the package may transition from its low power state to the active C0 state. Then on each core, any break events that have been buffered may be fetched (block 370). For example, during the delay period in which the package is in an idle state, one or more devices coupled to the package may have buffered break events destined to the package. Thus, upon waking of the individual cores, these break events may be fetched. Accordingly, at block 380, the break events may be serviced in their original timing. That is, the buffered break events may be serviced in the order in which they were buffered (e.g., on a first in first out basis). After servicing of any break events, any tasks scheduled for the core may then be performed according to their original timing. That is, after handling the break events any tasks scheduled to each core may be processed in the order of their original scheduling. While shown with this particular implementation in the embodiment of FIG. 4, the scope of the present invention is not limited in this regard and other manners of delaying processing of tasks and break events on a package may be realized to enable relatively long, continuous idle periods in which the package can be placed in a package low power state.

In contrast to embodiments such as described above, using a conventional OS scheduler, tasks and break events are serviced immediately, causing cores and the package to frequently to enter and exit idle states. Since periods of minimal idles do not permit use of long-latency and low-power deep package C-states, only the package C1 state can be used. Also conventional OS scheduler cores' busy times are not overlapped, causing a package to remain in C0 while only a single core is busy. Assume using conventional scheduling that of a 500 μs period, the total time spent in the package C0 state is 125 μs, and total time in the package C1 state is 375 μs. Instead, using an embodiment of the present invention predicting a first core's utilization of 10% and a second core's utilization of 15%, then the maximum core's utilization (U_max) is 15%. Accordingly, the determined delay period T* may be set as follows:

T*=interval time×(100%−U_max) [EQ 7]

where U_max is expressed as a percentage (i.e., 15% is expressed as 15). In this case, T*=500*(100%-15%)=425 μs, and the package in the coming 500 μs will get 425 μs of continuous idle time, which can enable a deeper low power state such as the package C3 state. Thereafter the 425 μs watchdog timer expires, the package returns to the C0 state and each core will process all tasks and break events in their original timing. Example processor power specifications and power consumption using a conventional scheduling and in accordance with one embodiment of the present invention, for an example 15% system load level are shown in Table 2.

TABLE 2

| | |
|---|---|
| Processor power consumption | Power(C0) = 130 W |
| | Power(C1) = 28 W |
| | Power(C3) = 18 W |
| Conventional OS scheduling | Power(C0) * 70% + Power(C1) * |
| | 30% * 52% + Power(C3) * 30% * |
| | 48% = 97.96 W |
| Scheduling using embodiment of | Power(C0) * 20% + Power(C3) * |
| present invention | 80% = 40.4 W |
| Difference (or theoretical upper | 57.56 W (or 58.8%) |
| limit of power saving) | |

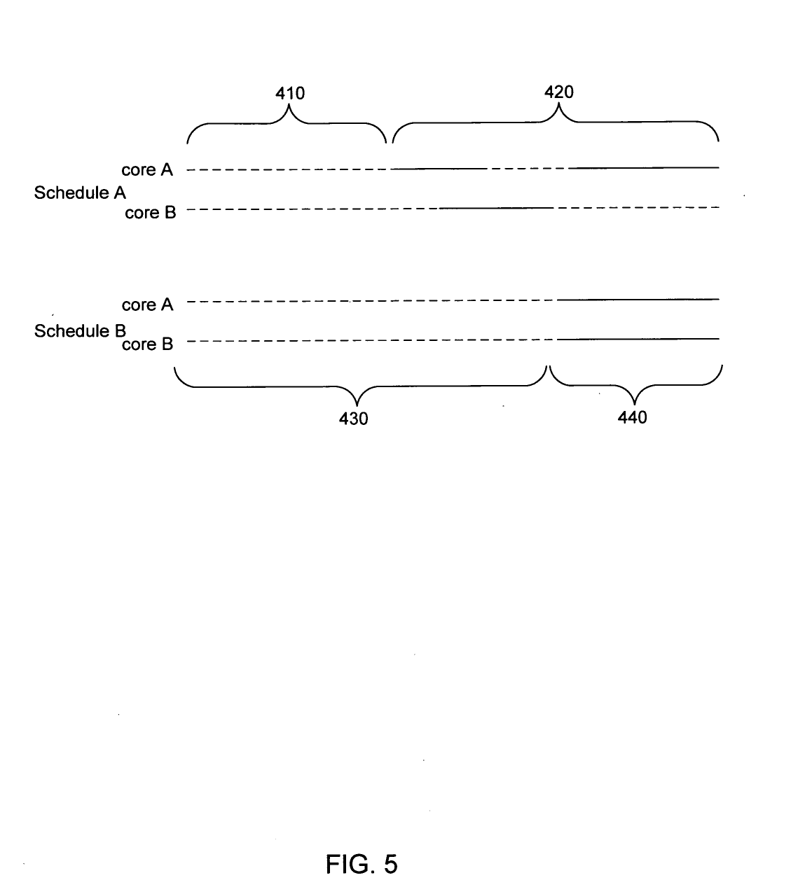

Referring now to FIG. 5, shown is a timing diagram of scheduling tasks to multiple cores of a package according to a conventional OS scheduling algorithm and according to an embodiment of the present invention. As shown in FIG. 5, assume a first core A and a second core B are present in a processor package. Schedule A corresponds to a conventional scheduling. At an initial time duration 410 of an activity interval, which may correspond to 500 μs, both cores may be in an idle state (represented by a dashed line) and thus the package may be placed into the package C1 state. That is, although both cores are idle, because tasks are scheduled onto both cores in the near future, the latency needed to enter into a greater low power state exceeds its benefit. Thus, the package is placed only into the package C1 state. Then shown beginning at time 420, the package is transitioned to the active C0 state, as from that time forward at least one of the two cores is busy (the active state is represented by the solid lines) executing tasks or other operations.

In contrast, with reference to schedule B, scheduled in accordance with an embodiment of the present invention, a delay period corresponding to time duration 430 is provided at a beginning of the operation interval. Because of the extended duration of this delay period 430, which may be 425 μs, the package may be placed in a deeper low power state, e.g., a package C3 state (or even deeper C-state), thus enabling greatly enhanced power savings, on the order of approximately 60% more than that of schedule A. At the conclusion of this delay period 430, the package is placed into the active state and thus for the remaining duration of the operation interval, the package is in the package C0 state for time duration 440. While not shown in FIG. 5, understand that individual cores may enter into core low power states (e.g., core C-states) during this active period. For example, all cores may be in the active state at a beginning of the active period, and as tasks and break events are completed, individual cores can be placed into a core low power state. Thus in this particular example, where a 15% load level exists, no performance impact occurs, while achieving 60% greater power savings than a conventional scheduling. Embodiments thus enable improved processor power consumption and no performance impact.

For purposes of example, Table 3 below shows package C-states and their descriptions, along with the estimated power consumption in these states, with reference to an example processor having a thermal design power (TDP) of 130 watts (W). Of course it is to be understood that this is an example only, and embodiments are not limited in this regard.

TABLE 3

| | | Estimated power |
|---|---|---|
| | Description | consumption |
| Package | All uncore and core logics active | 130 W |
| (Pkg) C0 | | |
| Pkg C1 | All cores inactive, package (pkg) | 28 W |
| | clockgated | |
| Pkg C3 | Pkg C1 state + all external links to | 18 W |
| | long-latency idle states + put memory | |
| | in short-latency inactive state | |
| Pkg C6 | Pkg C3 state + reduced voltage for | 10 W |
| | powerplane (only very low retention | |
| | voltage remains) + put memory in | |
| | long-latency inactive state | |
| Pkg C7 | Pkg C6 state + last level cache (LLC) | 5 W |
| | shrunk | |

While described herein as OS-based scheduling, embodiments are not limited m this regard. That is, in other implementations, software, firmware or hardware may be adapted on a package basis or at another location within a system, such as a power management unit (PMU) to enable dynamic rescheduling of tasks within an operating interval such that extended, continuous idle periods within each operating interval may be realized, enhancing the ability to enter into extended and deeper low power states on a package basis. Furthermore, while shown in FIG. 5 as providing the delay period at the beginning of an operation interval, the scope of the present invention is not limited in this regard and in other implementations, processing may be performed up front, followed by the delay period.

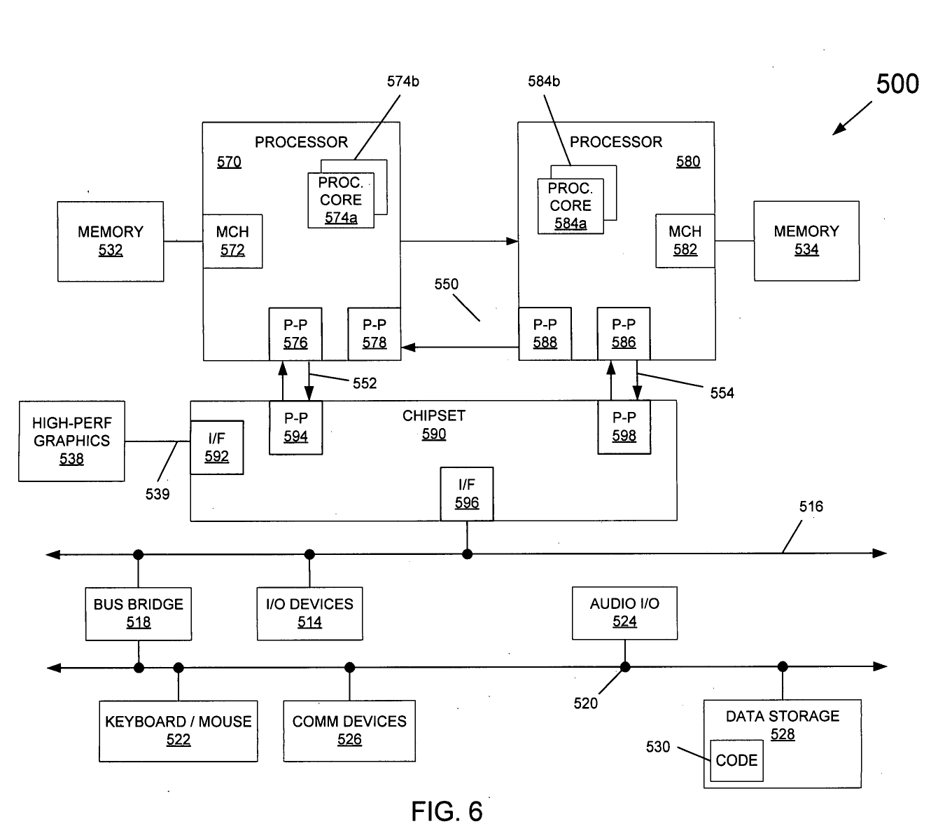

Embodiments may be implemented in many different system types. Referring now to FIG. 6, shown is a block diagram of a system in accordance with an embodiment of the present invention. As shown in FIG. 6, multiprocessor system 500 is a point-to-point interconnect system, and includes a first processor 570 and a second processor 580 coupled via a point-to-point interconnect 550. As shown in FIG. 6, each of processors 570 and 580 may be multicore processors, including first and second processor cores (i.e., processor cores 574a and 574b and processor cores 584a and 584b), although additional cores may be present in the processors. Each processor 570 and 580 may be controlled to be in a lower package C* state as a delay period T* can be determined and set. Each processor may further include hardware, software, firmware or combinations thereof to enable monitoring of utilization, and generating and using prediction information to enable determination of a delay period for a next operation interval in accordance with an embodiment of the present invention.

Still referring to FIG. 6, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 2, MCH's 572 and 582 couple the processors to respective memories, namely a memory 532 and a memory 534, which may be portions of main memory (e.g., a dynamic random access memory (DRAM)) locally attached to the respective processors. First processor 570 and second processor 580 may be coupled to a chipset 590 via P-P interconnects 552 and 554, respectively. As shown in FIG. 6, chipset 590 includes P-P interfaces 594 and 598.

Furthermore, chipset 590 includes an interface 592 to couple chipset 590 with a high performance graphics engine 538, by a P-P interconnect 539. In turn, chipset 590 may be coupled to a first bus 516 via an interface 596. As shown in FIG. 6, various I/O devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving prediction information regarding utilization of a plurality of cores of a processor package for a next operation interval;
setting a delay period for the processor package during the next operation interval based on the prediction information; and
causing the processor package to enter into a package low power state for the delay period and thereafter causing the processor package to enter into a package active state for an active period of the next operation interval, the delay period extending from a beginning of the next operation interval to a beginning of the active period.

2. The method of claim 1, further comprising initializing a timer of the processor package to a length of the delay period, and initiating the active period when the timer times out.

3. The method of claim 2, further comprising receiving the prediction information and setting the delay period in an operating system (OS) and transmitting a value of the delay period from the OS to the processor package to initialize the timer.

4. The method of claim 1, wherein the active period corresponds to a duration sufficient to execute tasks and break events scheduled to a core of the plurality of cores having a greatest predicted utilization.

5. The method of claim 4, wherein the delay period corresponds to NOI×(100%-Uₘₐₓ), where NOI corresponds to the next operation interval, and Uₘₐₓ is the greatest predicted utilization.

6. The method of claim 4, wherein the active period and the delay period are each of a continuous time duration.

7. The method of claim 4, further comprising fetching the break events from a buffer external to the processor package after the beginning of the active period.

8. The method of claim 7, further comprising servicing the break events and thereafter servicing the tasks, wherein the break events and the tasks are serviced according to an original scheduling delayed by the delay period.

9. The method of claim 1, wherein all the cores of the processor package are in an idle state for the delay period, and all the cores are in an active state for at least a first portion of the active period.

10. An apparatus comprising:
a multicore processor including a plurality of cores to service tasks and break events;
a monitor coupled to the multicore processor to receive utilization information for the plurality of cores for a current utilization cycle;
a predictor coupled to the monitor to predict a utilization rate for each of the plurality of cores for a next utilization cycle based on the utilization information; and
a scheduler coupled to the predictor to receive the utilization rates and to determine a delay period for the next utilization cycle based on at least one of the utilization rates, wherein the plurality of cores are to be idle during the delay period.

11. The apparatus of claim 10, wherein the multicore processor includes a timer to control the delay period, and the multicore processor is to be in a package low power state during the delay period.

12. The apparatus of claim 11, wherein the multicore processor is to enter into an active period following the delay period, wherein the active period corresponds to a duration sufficient to execute tasks and break events scheduled to a core of the plurality of cores having a greatest predicted utilization, and wherein the delay period and the active period are of a continuous time duration.

13. The apparatus of claim 12, wherein the delay period corresponds to:
NUC×(100%-Uₘₐₓ), where NUC corresponds to the next utilization cycle, and Uₘₐₓ is the greatest predicted utilization.

14. The apparatus of claim 12, wherein the multicore processor is to fetch the break events from a buffer external to the multicore processor after entry into the active period.

15. The apparatus of claim 12, wherein the scheduler is to reschedule an original timing for a plurality of tasks from within the delay period to within the active period.

16. The apparatus of claim 15, wherein the multicore processor is to execute the plurality of tasks in the active period according to the original timing.

17. An article comprising a machine-accessible medium including instructions that when executed cause a system to:
determine a delay period corresponding to a difference between a length of a next operation interval and a length of time to service operations in the next operation interval scheduled to a core of a multicore processor having a highest predicted utilization rate for the next operation interval; and
control entry of the multicore processor into a package low power state at a beginning of the next operation interval and exit of the multicore processor from the package low power state to a package active state at a conclusion of the delay period.

18. The article of claim 17, further comprising instructions that enable the system to receive a prediction value corresponding to a prediction for the core and determine the delay period in an operating system (OS) and transmit a value of the delay period from the OS to the multicore processor to initialize a timer of the multicore processor.

19. The article of claim 17, wherein the delay period corresponds to NOI×(100%-Uₘₐₓ), where NOI corresponds to the next operation interval, and Uₘₐₓ is the highest predicted utilization rate.

20. The article of claim 19, wherein the instructions enable the system to fetch break events from a buffer external to the multicore processor after the delay period and service the break events and thereafter service tasks scheduled to the multicore processor, wherein the break events and the tasks are serviced according to an original scheduling delayed by the delay period.

21. A system comprising:
a processor package including a plurality of cores and at least one timer, wherein the processor package is to be in a package low power state for a first portion of an operation interval and in a package active state for a second portion of the operation interval, wherein operations scheduled for the plurality of cores during the first portion are delayed until the second portion; and
a memory coupled to the processor package.

22. The system of claim 21, wherein the at least one timer is to be set by an operating system (OS) scheduler to a length of the first portion, and wherein the processor package is to exit the package low power state responsive to the at least one timer.

23. The system of claim 22, wherein the OS scheduler is to determine the length of the first portion based on a prediction value for a core of the processor package having a highest predicted utilization rate during the operation interval, wherein the length of the first portion corresponds to a difference between a length of the operation interval and a length of time to service the operations scheduled to the core.

24. The system of claim 21, wherein all of the plurality of cores are to be in a low power state during the package low power state, and at least some of the cores are to be in an active state during the package active state, and wherein the first and second portions of the operation interval are contiguous and collectively extend from a beginning to an end of the operation interval.
